(19) United States
(12) Patent Application Publication
(10) Pub. No.: US 2008/0008377 A1
(43) Pub. Date: Jan. 10, 2008

(54) Postal indicia categorization system

(75) Inventors: Richard S. Andel, Binghamton, NY (US); Sean Corrigan, Endicott, NY (US); Rosemary D. Paradis, Vestal, NY (US); Kenei Suntarat, Endicott, NY (US); Dennis A. Tillotson, McDonough, NY (US)

Correspondence Address: TAROLLI, SUNDHEIM, COVELL & TUMMINO LLP, Suite 1700, 1300 East Ninth Street, CLEVELAND, OH, 44114, US

(73) Assignee: Lockheed Martin Corporation

(21) Appl. No.: 11/482,418

(22) Filed: Jul. 7, 2006

(51) Int. Cl. G06K 9/00; G06K 9/46; G06K 9/64; G06K 9/66

(52) U.S. Cl. 382/141; 382/190; 382/223

(57) ABSTRACT

A system is presented for recognizing and identifying postal indicia on an envelope. The system includes an image acquisition element that acquires a first image, representing a first side of the envelope, and a second image, representing a second side of the envelope, and generates first and second candidate images from respective opposing corners of the first image and third and fourth candidate images from respective opposing corners of the second image. A feature extractor that, for each candidate image, divides the candidate image into a plurality of regions, extracts a plurality of numerical feature values from each of the plurality of regions, and recombines the plurality of feature values into a feature vector that represents the image. A classification element classifies the image into one of a plurality of output classes representing various types of postal indicia according to the numerical feature vector.

### BACKGROUND OF THE INVENTION

In mail handling applications, a limited amount of time is available to make a decision about any one envelope that is input into the mail stream. For example, postal indicia, that is non-address data on an envelope or package, must be scanned, located, and recognized in a period on the order of one hundred milliseconds to maintain the flow of mail through the system. These time constraints limit the available solutions for accurately classifying and verifying postal indicia on an envelope.

The problem is further complicated by the fact that the orientation of the envelope in the mail handling system is not standard. While many systems maintain the envelope in a generally vertical (i.e., longest edge vertical) position, it is possible that the envelope will be rotated to a position opposite the standard orientation or flipped such that the back of the envelope is facing upwards. In these cases, the postal indicia to be identified may not be in the expected location.

### SUMMARY OF THE INVENTION

In accordance with one aspect of the present invention, a system is presented for recognizing and identifying postal indicia on an envelope. The system includes an image acquisition element that acquires a first image, representing a first side of the envelope, and a second image, representing a second side of the envelope, and generates first and second candidate images from respective opposing corners of the first image and third and fourth candidate images from respective opposing corners of the second image. A feature extractor that, for each candidate image, divides the candidate image into a plurality of regions, extracts a plurality of numerical feature values from each of the plurality of regions, and recombines the plurality of feature values into a feature vector that attempts to represent the image for a classifier. A classification element classifies the image into one of a plurality of output classes representing various types of postal indicia according to the numerical feature vector.

In accordance with another aspect of the present invention, a computer program product, operative in a data processing system and implemented on a computer readable medium, is provided that categorizes postal indicia from at least one binarized image of an envelope. An image acquisition element isolates a plurality of predefined regions of interest within the at least one binarized image of the envelope and generates a candidate image from each of the plurality of regions of interest. A feature extraction element divides a given candidate image into a plurality of regions and, for each region, constructs a histogram count of the occurrence of a plurality of categories of pixel patterns within a plurality of defined two-pixel by two-pixel squares within the region. A classification element classifies the image into one of a plurality of output classes representing various types of postal indicia according to the constructed histogram counts from the plurality of regions.

In accordance with yet another aspect of the present invention, a method is provided for categorizing postal indicia into one of a plurality of output classes. At least one image of an envelope is acquired. A plurality of predefined regions of interest within the at least one acquired image of the envelope are acquired. A candidate image is generated from each of the plurality of regions of interest. Each candidate image is divided into a plurality of regions. A plurality of numerical feature values are extracted from each of the plurality of regions associated with a given candidate image. The extracted numerical feature values from each of the plurality of regions associated with a given candidate image are combined into a single feature vector representing the candidate image. For each candidate image, a set of output values is determined, corresponding to the plurality of output classes, from the feature vector. A given output value represents the likelihood that the candidate image belongs to an output class associated with the output value. The set of output values is provided to at least one downstream analysis element that determines at least one characteristic of the envelope according to the set of output values and at least one additional input representing the envelope.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 illustrates an indicia recognition system in accordance with an aspect of the present invention;

FIG. 2 illustrates a graphical representation of an exemplary image acquisition and feature extraction process in accordance with an aspect of the present invention;

FIG. 3 illustrates an exemplary set of pattern categories in accordance with an aspect of the present invention;

FIG. 4 illustrates an exemplary artificial neural network classifier;

FIG. 5 illustrates a methodology for identifying postal indicia on an envelope in accordance with an aspect of the present invention;

FIG. 6 illustrates an exemplary mail handling system incorporating an indicia categorization system in accordance with an aspect of the present invention;

FIG. 7 illustrates an exemplary image processing system for a mail handling system in accordance with an aspect of the present invention; and

FIG. 8 illustrates a computer system that can be employed to implement systems and methods described herein.

### DETAILED DESCRIPTION OF THE INVENTION

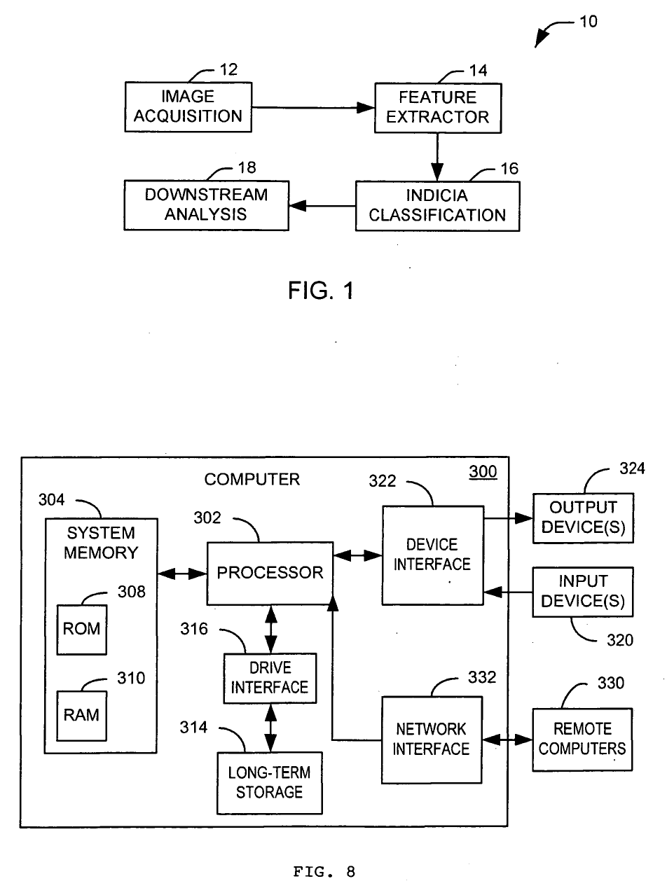

The present invention relates to systems and methods for the real-time recognition of postal indicia. FIG. 1 illustrates an indicia recognition system 10 that locates and identifies postal indicia in accordance with an aspect of the present invention.

It will be appreciated that the characteristics of various postal indicia can vary significantly, and that different methods of analysis may be desirable for envelopes containing various types of indicia. For example, an algorithm utilized to identify a particular type of stamp and determine its value can be expected to differ significantly from an algorithm to determine the value of a metermark on metered envelope. Given the time constraints present in a mail handling system, applying these methods sequentially would be unacceptably inefficient.

It is equally problematic to apply the various analysis methodologies associated with the indicia types in parallel. At any given time, a CPU associated with a mail sorting system will be processing data associated with a number of envelopes. Conducting the analysis for multiple indicia would be an unnecessary use of processing resources at the expense of other classification tasks. Further, knowledge of the position of the postal indicia on an envelope provides an indication of the orientation and facing of the envelope. Reliable knowledge of the orientation and facing of the envelope allows for simplification of future analysis of the envelope image (e.g., optical character recognition of all or a portion of the address, postage verification, etc.). Further, once the envelope is oriented and faced, it is canceled and sprayed with an identification tag. In order to process the mail appropriately, the cancellation and the id tag need to be placed in the correct location on the envelope.

To this end, the illustrated system 10 is designed to identify a general category of indicia in an extremely short period of time, generally on the order of tens of milliseconds. During this time, the system classifies each of a plurality of predefined regions of interest into one of a plurality of indicia classes. In an exemplary implementation, the plurality of classes can include a “blank” class representing an absence of indicia within a given region of interest. It is necessary that indicia recognition system operate with great efficiency to retain time and processing resources for the downstream analysis of the envelope that the indicia recognition system 10 is intended to facilitate.

One or more candidate images are acquired for analysis at an image acquisition element 12. The image acquisition element 12 acquires at least one image of an envelope and isolates at least one candidate image from at least one predetermined location on the acquired at least one image. For example, in one implementation, respective lead and trail cameras on either side of a conveyer belt associated with the mail sorting system are used to take an image of each side of the envelope, such that a first image represents a front side of the envelope and second image represents a back side of the envelope. It will be appreciated that these images can comprise grayscale and color images of various resolutions that can be binarized, such that each pixel is represented by a single bit as “dark” or “white”.

In an exemplary embodiment, one or more predetermined regions of interest are selected within the front and back images of the envelope to represent positions in which indicia are expected to appear. In accordance with postal standards, the classes of postal indicia of interest for the system 10 are found in a specific corner of the front side envelope. Assuming that the envelope is maintained in a vertical position (i.e., longest edge vertical), but that the orientation and facing of the envelope is otherwise unknown, the corner of the envelope traditionally associated with the postal indicia classes of interest can only appear in one of four positions. Specifically, the indicia will be in the upper left corner of the front of the envelope in a “normal” orientation, but the envelope can rotated one hundred eighty degrees, flipped to where the back of the envelope faces the lead camera, or both flipped to the back side and rotated one hundred eighty degrees.

To take advantage of this, the regions of interest can include the upper left corner and the lower right corner of the output of the lead camera, and the upper right corner and the lower left corner of the output of the trail camera. Accordingly, four candidate images, representing these regions of interest, can be isolated from the first and second images for further analysis.

Each candidate image is provided to a feature extractor 14 that extracts features from the isolated region of interest. The feature extractor 14 derives a vector of numerical measurements, referred to as feature variables, from the candidate image. Thus, the feature vector represents the character image sample in a modified format that attempts to represent as many aspects of the original image as possible.

The features used to generate the feature vector are selected both for their effectiveness in distinguishing among a plurality of categories of postal indicia and for their ability to be quickly extracted from the image sample. For example, in an exemplary implementation, the feature values are determined by dividing the candidate image into a plurality of regions. Each region is further subdivided into 2-pixel by 2-pixel squares, with each 2-pixel by 2-pixel square representing one of a plurality of possible pixel patterns.

The extracted feature vector is then provided to an indicia classification system 16. The indicia classification system 16 classifies the candidate image into one of a plurality of output classes representing different types of postal indicia. For example, the plurality of output classes can include classes representing metermarks, business reply mail markings, information based indicia (e.g., bar codes), stamps, blank regions, as well as a generic “other” class. The indicia classification system 16 can include one or more classifiers of various types including statistical classifiers, neural network classifiers, and self-organizing maps that have been designed or adapted to distinguish among the various postal indicia according to the features associated with the feature extractor 14.

For example, the indicia classification system 16 can include an artificial neural network trained to distinguish among various classes of postal indicia according to the extracted feature. A neural network is composed of a large number of highly interconnected processing elements that have weighted connections. It will be appreciated that these processing elements can be implemented in hardware or simulated in software. The organization and weights of the connections determine the output of the network, and are optimized via a training process to reduce error and generate the best output classification.

The values comprising the feature vector are provided to the inputs of the neural network, and a set of output values corresponding to the plurality of output classes is produced at the neural network output. Each of the set of output values represent the likelihood that the candidate image falls within the output class associated with the output value. The output class having the optimal output value is selected. What constitutes an optimal value will depend on the design of the neural network. In one example, the output class having the largest output value is selected.

The output of the indicia classification system 16 can then be provided to one or more downstream analysis systems 18 that provide further analysis of the envelope image, or alternate representations thereof, according to the output of the classification system 16 and at least one additional input representing the envelope. For example, the downstream analysis systems 18 can include an orientation element that determines an associated orientation of the envelope at least in part from the determined type and position of the indicia on the envelope. The downstream analysis systems 18 can also include one or more specialized classifiers, each of which identify specific postal indicia within one of the broader category of postal indicia recognized by the system 10.

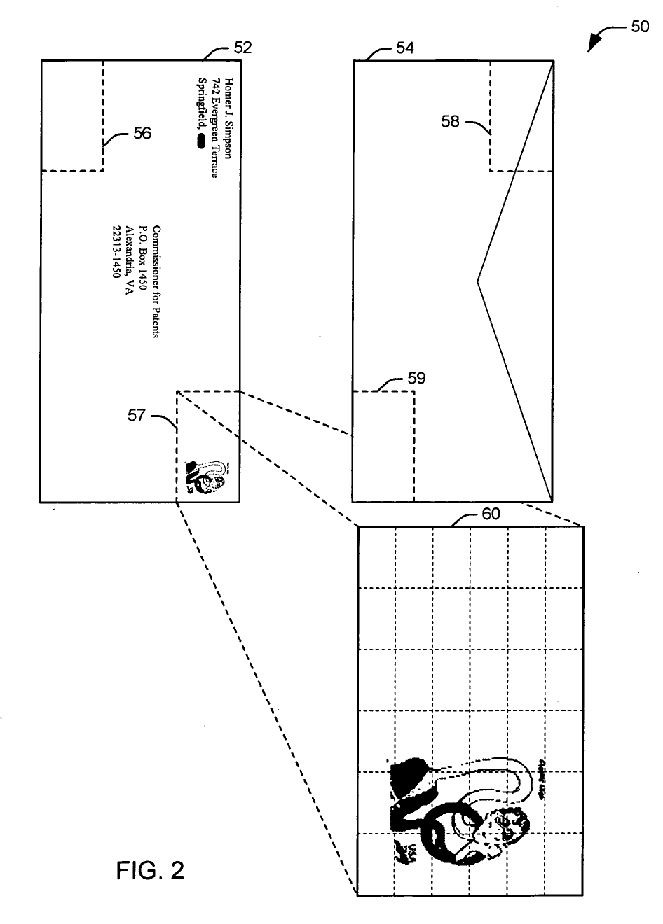

FIG. 2 provides a graphical representation 50 of an exemplary image acquisition and feature extraction process in accordance with an aspect of the present invention. The process begins when at least one envelope image is provided to an indicia recognition system. In the illustrated example, a first binarized image 52, representing a first side of the envelope, and a second binarized image 54, representing a second side of the envelope, can be provided to the system. For example, the first image 52 can represent the output of a lead camera within the mail sorting system and the second image 54 can represent the output of a trail camera located on the opposite side of a conveyer belt that transports the envelope through the mail sorting system.

In accordance with an aspect of the present invention, four predefined regions of interest 56-59 can be isolated from the envelope images 52 and 54 to produce four candidate image snippets for each envelope. These regions are preselected as the most likely locations for postal indicia, assuming the indicia to be placed in the traditional corner of the envelope in accordance with postal standards. Each candidate image is then further divided into a plurality of candidate regions. In the illustrated example, the region is divided into thirty-six regions via a six-by-six grid 60.

In accordance with an aspect of the present invention, each of the plurality of regions is then analyzed to produce a plurality of feature values. In the illustrated example, each of the plurality of regions is divided into two-pixel by two-pixel squares. It will be appreciated that each of the two-pixel by two-pixel squares can exhibit only one of a finite number of patterns, according to the bit values of the pixels comprising the squares. Numerical feature values for the region can be determined as a count of the number of squares falling into each region. In essence, the feature values for each region are a histogram count of the prevalence of each of the plurality of pattern types in the region.

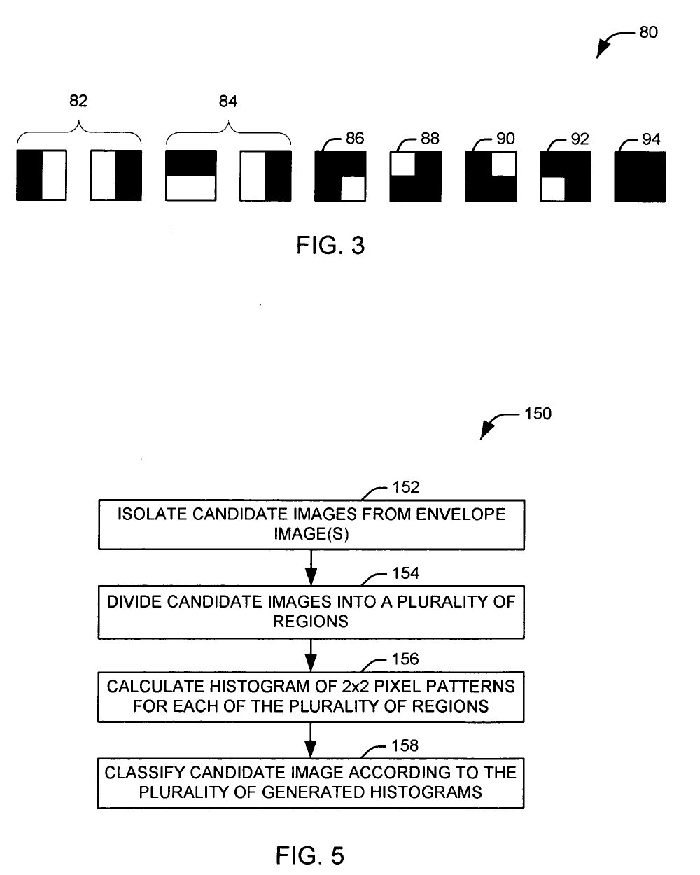

FIG. 3 illustrates an exemplary set 80 of pattern categories in accordance with an aspect of the present invention. In the illustrated implementation, only two-pixel by two-pixel patterns having at least two dark pixels are counted by the system. Accordingly, areas that are primarily white space are ignored. A first category 82 of patterns comprises all patterns having two dark pixels in one column of the pattern and two white pixels in another column, regardless of the position of the columns. Similarly, a second category 84 of patterns comprises all patterns having two dark pixels in one row of the pattern and two white pixels in another row, regardless of the position of the rows.

The next four pattern categories 86, 88, 90, and 92 cover all cases in which the two-pixel by two-pixel squares contain three dark pixels and one white pixel. In the third pattern category 86, the white pixel is in the bottom left position, in the fourth pattern category 88, the white pixel is in the top left position, in the fifth pattern category 90, the white pixel is in the top right position, and in the sixth pattern category 92, the white pixel is in the bottom right position. Finally, the seventh pattern category 94 includes patterns where all four pixels are dark. Accordingly, a histogram including these pixels will provide information related to the more densely populated dark pixel regions, as these areas of the candidate image are most likely to include postal indicia.

Once a histogram of the patterns comprising each region has been generated, the histogram values for each region can be combined into a single feature vector. In the illustrated example, this feature vector will contain seven values for each of the thirty-six regions for a total of two hundred fifty-two feature values. This feature vector is then provided for analysis at an associated classifier.

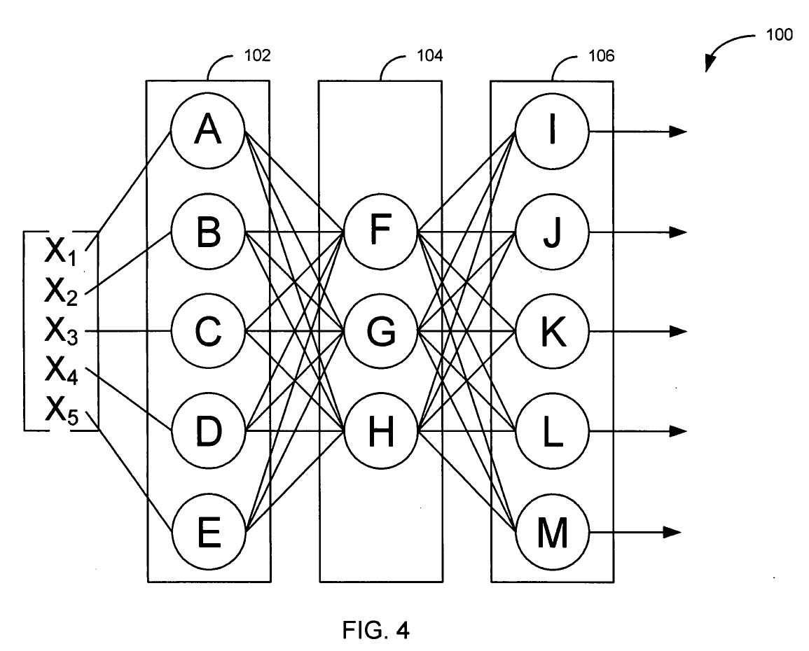

FIG. 4 illustrates an exemplary artificial neural network classifier 100. The illustrated neural network is a three-layer back-propagation neural network suitable for use in an elementary pattern classifier. It should be noted here, that the neural network illustrated in FIG. 4 is a simple example solely for the purposes of illustration. Any non-trivial application involving a neural network, including pattern classification, may require a network with many more nodes in each layer and/or additional hidden layers. It will further be appreciated that a neural network can be implemented in hardware as a series of interconnected hardware processors or emulated as part of a software program running on a data processing system.

In the illustrated example, an input layer 102 comprises five input nodes, A-E. A node, or neuron, is a processing unit of a neural network. A node may receive multiple inputs from prior layers which it processes according to an internal formula. The output of this processing may be provided to multiple other nodes in subsequent layers.

Each of the five input nodes A-E receives input signals with values relating to features of an input pattern. Preferably, a large number of input nodes will be used, receiving signal values derived from a variety of pattern features. Each input node sends a signal to each of three intermediate nodes F-H in a hidden layer 104. The value represented by each signal will be based upon the value of the signal received at the input node. It will be appreciated, of course, that in practice, a classification neural network can have a number of hidden layers, depending on the nature of the classification task.

Each connection between nodes of different layers is characterized by an individual weight. These weights are established during the training of the neural network. The value of the signal provided to the hidden layer 104 by the input nodes A-E is derived by multiplying the value of the original input signal at the input node by the weight of the connection between the input node and the intermediate node (e.g., G). Thus, each intermediate node F-H receives a signal from each of the input nodes A-E, but due to the individualized weight of each connection, each intermediate node receives a signal of different value from each input node. For example, assume that the input signal at node “A” is of a value of 5 and the weights of the connections between node “A” and nodes F-H are 0.6, 0.2, and 0.4 respectively. The signals passed from node “A” to the intermediate nodes F-H will have values of 3, 1, and 2.

Each intermediate node F-H sums the weighted input signals it receives. This input sum may include a constant bias input at each node. The sum of the inputs is provided into a transfer function within the node to compute an output. A number of transfer functions can be used within a neural network of this type. By way of example, a threshold function may be used, where the node outputs a constant value when the summed inputs exceed a predetermined threshold. Alternatively, a linear or sigmoidal function may be used, passing the summed input signals or a sigmoidal transform of the value of the input sum to the nodes of the next layer.

Regardless of the transfer function used, the intermediate nodes F-H pass a signal with the computed output value to each of the nodes I-M of the output layer 106. An individual intermediate node (i.e. G) will send the same output signal to each of the output nodes I-M, but like the input values described above, the output signal value will be weighted differently at each individual connection. The weighted output signals from the intermediate nodes are summed to produce an output signal. Again, this sum may include a constant bias input.

Each output node represents an output class of the classifier. The value of the output signal produced at each output node is intended to represent the probability that a given input sample belongs to the associated class. In the exemplary system, the class with the highest associated probability is selected, so long as the probability exceeds a predetermined threshold value. The value represented by the output signal is retained as a confidence value of the classification.

In view of the foregoing structural and functional features described above, methodology in accordance with various aspects of the present invention will be better appreciated with reference to FIG. 5. While, for purposes of simplicity of explanation, the methodology of FIG. 5 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect the present invention.

FIG. 5 illustrates a methodology 150 for identifying postal indicia on an envelope in accordance with an aspect of the present invention. The process begins at step 152, where one or more regions of interest are isolated within at least one image of an envelope to produce respective candidate images. In accordance with an aspect of the present invention, the regions of interest can include opposing first and second corners of each of the at least one envelope image. At step 154, each candidate image is divided into a plurality of regions. For example, a six-by-six grid can be applied to each candidate image to divide the image into thirty-six regions of equal area.

At step 156, a histogram is calculated to represent the prevalence of a plurality of categories of two-pixel by two-pixel patterns within each region. Basically, a given region is divided into two-pixel by two-pixel squares and each square is either identified as belonging to one of the plurality of categories or determined to belong to none of the categories. The number of squares in each category is counted and the final counts for each region are incorporated into the histogram. At step 158, the candidate image is classified as one of a plurality of classes of postal indicia according to the calculated histograms for the plurality of regions comprising the image. For example, the values comprising the histograms can be provided to a neural network classifier that generates a plurality of output values, representing the plurality of output classes, a given output value indicating the likelihood that the candidate image belongs to the output class represented by the output value.

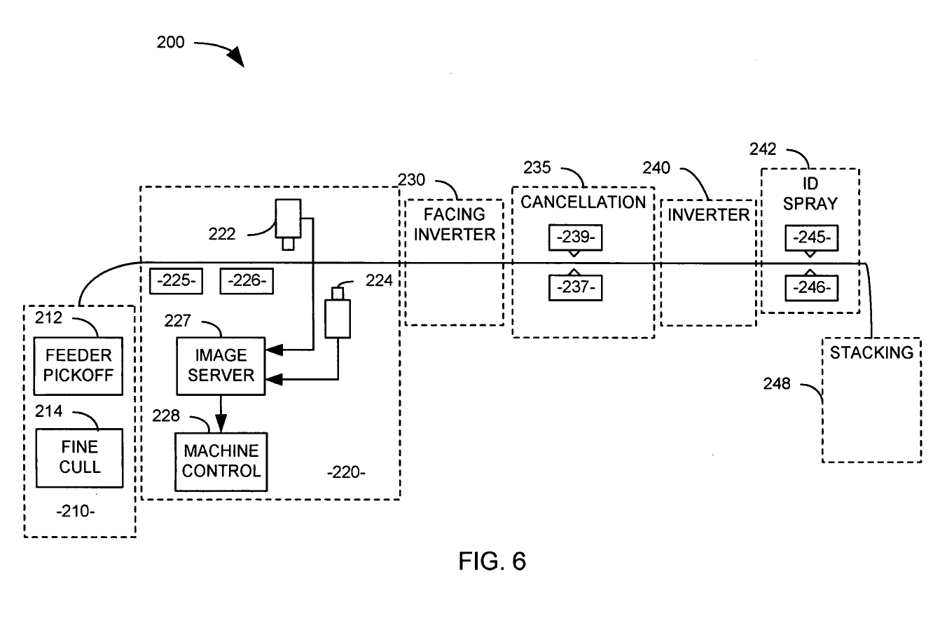

FIG. 6 illustrates an exemplary mail handling system 200 incorporating an indicia categorization system in accordance with an aspect of the present invention. The mail sorting system 200 comprises a singulation stage 210, an image lifting stage 220, a facing inversion stage 230, a cancellation stage 235, an inversion stage 240, an ID tag spraying stage 242, and a stacking stage 248. One or more conveyors (not shown) would move mailpieces from stage to stage in the system 200 (from left to right in FIG. 6) at a rate of approximately 3.6-4.0 meters per second.

A singulation stage 210 includes a feeder pickoff 212 and a fine cull 214. The feeder pickoff 212 would generally follow a mail stacker (not shown) and would attempt to feed one mailpiece at a time from the mail stacker to the fine cull 214, with a consistent gap between mailpieces. The fine cull 214 would remove mailpieces that were too tall, too long, or perhaps too stiff. When mailpieces left the fine cull 214, they would be in fed vertically (e.g., longest edge parallel to the direction of motion) to assume one of four possible orientations.

The the image lifting station 220 can comprise a pair of camera assemblies 222 and 224. As shown, the image lifting stage 220 is located between the singulation stage 210 and the facing inversion stage 230 of the system 200, but image lifting stage 220 may be incorporated into system 200 in any suitable location.

In operation, each of the camera assemblies 222 and 224 acquires both a low-resolution UV image and a high-resolution grayscale image of a respective one of the two faces of each passing mailpiece. Because the UV images are of the entire face of the mailpiece, rather than just the lower one inch edge, there is no need to invert the mailpiece when making a facing determination.

Each of the camera assemblies illustrated in FIG. 6 is constructed to acquire both a low-resolution UV image and a high-resolution grayscale image, and such assemblies may be used in embodiments of the invention. It should be appreciated, however, the invention is not limited in this respect. Components to capture a UV image and a grayscale image may be separately housed in alternative embodiments. It should be further appreciated that the invention is not limited to embodiments with two or more camera assemblies as shown. A single assembly could be constructed with an opening through which mailpieces may pass, allowing components in a single housing to form images of multiple sides of a mailpiece. Similarly, optical processing, such as through the use of mirrors, could allow a single camera assembly to capture images of multiple sides of a mailpiece.

Further, it should be appreciated that UV and grayscale are representative of the types of image information that may be acquired rather than a limitation on the invention. For example, a color image may be acquired. Consequently, any suitable imaging components may be included in the system 200.

As shown, the system 200 may further include an item presence detector 225, a belt encoder 226, an image server 227, and a machine control computer 228. The item presence detector 225 (exemplary implementations of an item presence detector can include a “photo eye” or a “light barrier”) may be located, for example, five inches upstream of the trail camera assembly 222, to indicate when a mailpiece is approaching. The belt encoder 226 may output pulses (or “ticks”) at a rate determined by the travel speed of the belt. For example, the belt encoder 226 may output two hundred and fifty six pulses per inch of belt travel. The combination of the item presence detector 225 and belt encoder 226 thus enables a relatively precise determination of the location of each passing mailpiece at any given time. Such location and timing information may be used, for example, to control the strobing of light sources in the camera assemblies 222 and 224 to ensure optimal performance independent of variations in belt speed.

Image information acquired with the camera assemblies 222 and 224 or other imaging components may be processed for control of the mail sorting system or for use in routing mailpieces passing through the system 200. Processing may be performed in any suitable way with one or more processors. In the illustrated embodiment, processing is performed by image server 227. It will be appreciated that, in one implementation, an indicia classification system in accordance with an aspect of the present invention, could be implemented as a software program in the image server 227.

The image server 227 may receive image data from the camera assemblies 222 and 224, and process and analyze such data to extract certain information about the orientation of and various markings on each mailpiece. In some embodiments, for example, images may be analyzed using one or more neural network classifiers, various pattern analysis algorithms, rule based logic, or a combination thereof. Either or both of the grayscale images and the UV images may be so processed and analyzed, and the results of such analysis may be used by other components in the system 200, or perhaps by components outside the system, for sorting or any other purpose.

In the embodiment shown, information obtained from processing images is used for control of components in the system 200 by providing that information to a separate processor that controls the system. The information obtained from the images, however, may additionally or alternatively be used in any other suitable way for any of a number of other purposes. In the pictured embodiment, control for the system 200 is provided by a machine control computer 228. Though not expressly shown, the machine control computer 228 may be connected to any or all of the components in the system 200 that may output status information or receive control inputs. The machine control computer 228 may, for example, access information extracted by the image server 227, as well as information from other components in the system, and use such information to control the various system components based thereupon.

In the example shown, the camera assembly 222 and 224 is called the “lead” assembly because it is positioned so that, for mailpieces in an upright orientation, the indicia (in the upper right hand corner) is on the leading edge of the mailpiece with respect to its direction of travel. Likewise, the camera assembly 224 is called the “trail” assembly because it is positioned so that, for mailpieces in an upright orientation, the indicia is on the trailing edge of the mailpiece with respect to its direction of travel. Upright mailpieces themselves are also conventionally labeled as either “lead” or “trail” depending on whether their indicia is on the leading or trailing edge with respect to the direction of travel.

Following the last scan line of the lead camera assembly 222, the image server 227 may determine an orientation of “flip” or “no-flip” for the facing inverter 230. In particular, the inverter 230 is controlled so that that each mailpiece has its top edge down when it reaches the cancellation stage 235, thus enabling one of the cancellers 237 and 239 to spray a cancellation mark on any indicia properly affixed to a mailpiece by spraying only the bottom edge of the path (top edge of the mailpiece). The image server 227 may also make a facing decision that determines which canceller (lead 237 or trail 239) should be used to spray the cancellation mark. Other information recognized by the image server 227, such as information based indicia (IBI), may also be used, for example, to disable cancellation of IBI postage since IBI would otherwise be illegible downstream.

After cancellation, all mailpieces may be inverted by the inverter 242, thus placing each mailpiece in its upright orientation. Immediately thereafter, an ID tag may be sprayed at the ID spraying stage 244 using one of the ID tag sprayers 245 and 246 that is selected based on the facing decision made by the image server 227. In some embodiments, all mailpieces with a known orientation may be sprayed with an ID tag. In other embodiments, ID tag spraying may be limited to only those mailpieces without an existing ID tag (forward, return, foreign).

Following application of ID tags, the mailpieces may ride on extended belts for drying before being placed in output bins or otherwise routed for further processing at the stacking stage 248. Except for rejects, the output bins can be placed in pairs to separate lead mailpieces from trail mailpieces. It is desirable for the mailpieces in each output bin to face identically. The operator may thus rotate trays properly so as to orient lead and trail mailpieces the same way. The mail may be separated into four broad categories: (1) facing identification marks (FIM) used with a postal numeric encoding technique, (2) outgoing (destination is a different sectional center facility (SCF)), (3) local (destination is within this SCF), and (4) reject (detected double feeds, not possible to sort into other categories). The decision of outgoing vs. local, for example, may be based on the image analysis performed by the image server 227.

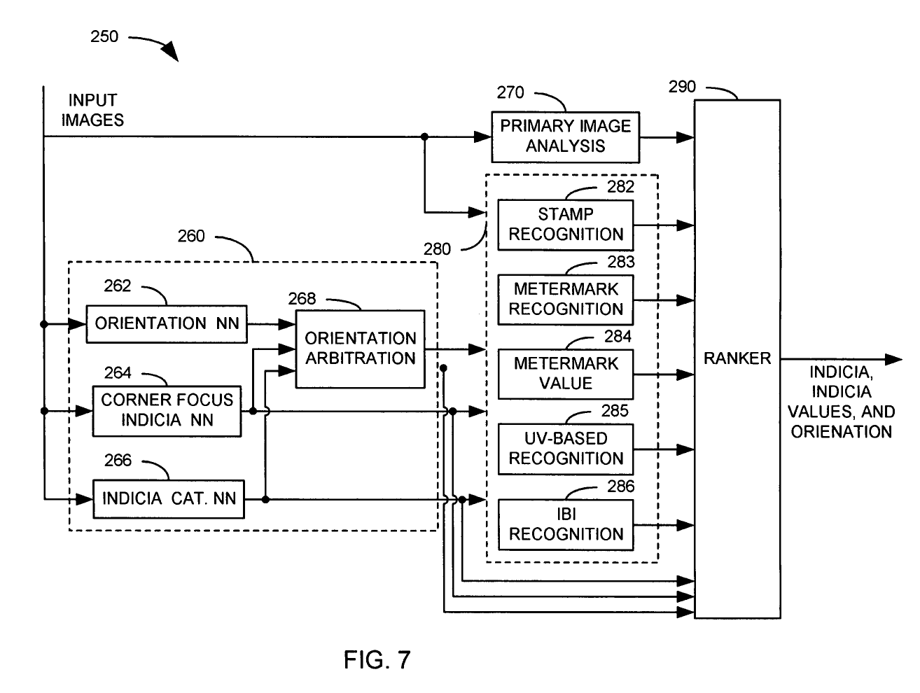

FIG. 7 illustrates an exemplary image processing system 250 for a mail handling system in accordance with an aspect of the present invention. The image processing system 250 can be roughly divided into two sequential stages. In a first stage, the orientation and facing of the envelope are determined as well as general information relating to the types of indicia located on the envelope. During the first processing stage, an orientation determination element 260 can be initiated to provide an initial determination of the orientation and facing of the envelope. In accordance with an aspect of the present invention, the first stage of image processing is designed to operate within less than one hundred eighty milliseconds.

One or more images can be provided to the orientation determination element 260 as part of the first processing stage. A plurality of neural network classifiers 262, 264, and 266 within the orientation determination element 260 are operative to analyze various aspects of the input images to determine an orientation and facing of the envelope. A first neural network classifier 262 determines an appropriate orientation for the envelope according to the distribution of dark pixels across each side of the envelope. A second neural network classifier 264 can comprise an indicia detection and recognition system that locates dense regions within the corners of an envelope and classifies the located dense regions into broad indicia categories. A third neural network classifier 266 can comprise an indicia categorization system in accordance with an aspect of the present invention.

The outputs of all three neural network classifiers 262, 264, and 266 are provided to an orientation arbitrator 268. The orientation arbitrator 268 determines an associated orientation and facing for the envelope according to the neural network outputs. In the illustrated implementation, the orientation arbitrator 268 is a neural network classifier that receives the outputs of the three neural network classifiers 262, 264, and 266 and classifies the envelope into one of four possible orientations.

Once an orientation for the envelope has been determined, a second stage of processing can begin. During the second stage of processing, one or more primary image analysis elements 270, various secondary analysis elements 280, and a ranking element 290 can initiate to provide more detailed information as to the contents of the envelope. In accordance with an aspect of the present invention, the second stage is operative to run in approximately two thousand two hundred milliseconds. It will be appreciated that during this time, processor resources can be shared among a plurality of envelopes.

The primary image analysis elements 270 are operative to determine one or more of indicia type, indicia value, and routing information for the envelope. Accordingly, a given primary image analysis element 270 can include a plurality segmentation routines and pattern recognition classifiers that are operative to recognize postal indicia, extract value information, isolate address data, and read the characters comprising at least a portion of the address. It will be appreciated that multiple primary analysis elements 270 can analyze the envelope content, with the results of the multiple analyses being arbitrated at the ranking element 290.

The secondary analysis elements 280 can include a plurality of classification algorithms that review specific aspects of the envelope. In the illustrated implementation, the plurality of classification algorithms can include a stamp recognition classifier 282 that identifies stamps on an envelope via template matching, a metermark recognition system 283, a metermark value recognition system 284 that locates and reads value information within metermarks, one or more classifiers 285 that analyze an ultraviolet florescence image, and a classifier 286 that identifies and reads information based indicia (ISI).

It will be appreciated that the secondary analysis elements 280 can be active or inactive for a given envelope according to the results at the second and third neural networks 264 and 266. For example, if it is determined with high confidence that the envelope contains only a stamp, the metermark recognition element 283, metermark value recognition element 284, and the IBI based recognition element 286 can remain inactive to conserve processor resources.

The outputs of the orientation determination element 260, the primary image analysis elements 270, and the secondary analysis elements 280 are provided to a ranking element 290 that determines a final output for the system 250. In the illustrated implementation, the ranking element 290 is a rule based arbitrator that determines at least the type, location, value, and identity of any indicia on the envelope according to a set of predetermined logical rules. These rules can be based on known error rates for the various analysis elements 260, 270, and 280. The output of the ranking element 290 can be used for decision making throughout the mail handling system.

FIG. 8 illustrates a computer system 300 that can be employed to implement systems and methods described herein, such as based on computer executable instructions running on the computer system. The computer system 300 can be implemented on one or more general purpose networked computer systems, embedded computer systems, routers, switches, server devices, client devices, various intermediate devices/nodes and/or stand alone computer systems. Additionally, the computer system 300 can be implemented as part of the computer-aided engineering (CAE) tool running computer executable instructions to perform a method as described herein.

The computer system 300 includes a processor 302 and a system memory 304. Dual microprocessors and other multi-processor architectures can also be utilized as the processor 302. The processor 302 and system memory 304 can be coupled by any of several types of bus structures, including a memory bus or memory controller, a peripheral bus, and a local bus using any of a variety of bus architectures. The system memory 304 includes read only memory (ROM) 308 and random access memory (RAM) 310. A basic input/output system (BIOS) can reside in the ROM 308, generally containing the basic routines that help to transfer information between elements within the computer system 300, such as a reset or power-up.

The computer system 300 can include one or more types of long-term data storage 314, including a hard disk drive, a magnetic disk drive, (e.g., to read from or write to a removable disk), and an optical disk drive, (e.g., for reading a CD-ROM or DVD disk or to read from or write to other optical media). The long-term data storage can be connected to the processor 302 by a drive interface 316. The long-term storage components 314 provide nonvolatile storage of data, data structures, and computer-executable instructions for the computer system 300. A number of program modules may also be stored in one or more of the drives as well as in the RAM 310, including an operating system, one or more application programs, other program modules, and program data.

A user may enter commands and information into the computer system 300 through one or more input devices 320, such as a keyboard or a pointing device (e.g., a mouse). These and other input devices are often connected to the processor 302 through a device interface 322. For example, the input devices can be connected to the system bus 306 by one or more a parallel port, a serial port or a universal serial bus (USB). One or more output device(s) 324, such as a visual display device or printer, can also be connected to the processor 302 via the device interface 322.

The computer system 300 may operate in a networked environment using logical connections (e.g., a local area network (LAN) or wide area network (WAN) to one or more remote computers 330. The remote computer 330 may be a workstation, a computer system, a router, a peer device or other common network node, and typically includes many or all of the elements described relative to the computer system 300. The computer system 300 can communicate with the remote computers 330 via a network interface 332, such as a wired or wireless network interface card or modem. In a networked environment, application programs and program data depicted relative to the computer system 300, or portions thereof, may be stored in memory associated with the remote computers 330.

It will be understood that the above description of the present invention is susceptible to various modifications, changes and adaptations, and the same are intended to be comprehended within the meaning and range of equivalents of the appended claims. The presently disclosed embodiments are considered in all respects to be illustrative, and not restrictive. The scope of the invention is indicated by the appended claims, rather than the foregoing description, and all changes that come within the meaning and range of equivalence thereof are intended to be embraced therein.

Having described the invention, we claim the following:

1. A system for recognizing and identifying postal indicia on an envelope, comprising:
an image acquisition element that acquires a first image, representing a first side of the envelope, and a second image, representing a second side of the envelope, and generates first and second candidate images from respective opposing corners of the first image and third and fourth candidate images from respective opposing corners of the second image;
a feature extractor that, for each candidate image, divided the candidate image into a plurality of regions, extracts a plurality of numerical feature values from each of the plurality of regions, and recombines the plurality of feature values into a feature vector that represents the image; and
a classification element that classifies the image into one of a plurality of output classes representing various types of postal indicia according to the numerical feature vector.

2. The system of claim 1, the classification element comprising a neural network classifier that receives a plurality of feature values comprising the feature vector as an input and outputs a plurality of values representing, respectively, the plurality of output classes.

3. The system of claim 1, wherein the candidate images are binarized images in which each pixel is represented as a single bit, and the plurality of numerical features extracted from each of the plurality of regions comprising a histogram count of the occurrence of a plurality of categories of pixel patterns within a plurality of defined two-pixel by two-pixel squares within the region.

4. The system of claim 1, the various types of postal indicia represented by the plurality of output classes comprising stamps, metermarks, business reply mail markings, and information based indicia.

5. The system of claim 1, the image acquisition element being operative to produce at least one binarized image of the envelope, such that at least one of the first image and the second image is a binarized image.

6. The system of claim 1, wherein the image acquisition element comprises a lead camera, positioned above a given envelope, that acquires the first image, and a trail camera, positioned below the envelope, that acquires the second image.

7. A mail handling system comprising:
the system of claim 1; and
at least one downstream analysis element that receives an associated output of the classification element and determines at least one characteristic of the envelope from the output of the classification element and a second input representing the envelope.

8. A mail handling system comprising:
the system of claim 1; and
a plurality of downstream analysis elements for determining a characteristic of the envelope, wherein at least one of the plurality of processing elements is selected to analyze an image of the envelope according to an associated output of the classification element.

9. A computer program product, operative in a data processing system and stored on a computer readable medium, that categorizes postal indicia from at least one binarized image of an envelope comprising:
an image acquisition element that isolates a plurality of predefined regions of interest within the at least one binarized image of the envelope and generates a candidate image from each of the plurality of regions of interest;
a feature extraction element that divides a given candidate image into a plurality of regions and, for each region, constructs a histogram count of the occurrence of a plurality of categories of pixel patterns within a plurality of defined two-pixel by two-pixel squares within the region; and
a classification element that classifies the image into one of a plurality of output classes representing various types of postal indicia according to the constructed histogram counts from the plurality of regions.

10. The computer program product of claim 9, the classification element comprising an artificial neural network classifier.

11. The computer program product of claim 9, wherein the at least one binarized image comprises a first binarized image, representing the output of a lead camera positioned above the envelope and a second binarized image, representing the output of a trail camera positioned below the envelope.

12. The computer program product of claim 11, wherein the predefined regions of interest comprise a first region encompassing the upper left corner of the first binarized image, a second region encompassing the lower right corner of the first binarized image, a third region encompassing the upper right corner of the second binarized image, and a fourth region encompassing the lower left corner of the second binarized image.

13. The computer program product of claim 9, wherein the plurality of output classes associated with the classification element comprise a blank class, a class representing stamps, a class representing metermarks, a class representing information based indicia, a class representing business reply mail markings, and an other class.

14. The computer program product of claim 9, wherein the plurality of categories of pixel patterns comprise at least a first category representing a two-pixel by two-pixel square having a column of white pixels and a column of dark pixels, a second category representing a two-pixel by two-pixel square having a row of white pixels and a row of dark pixels, and a third category two-pixel by two-pixel square having only dark pixels.

15. A method for categorizing postal indicia into one of a plurality of output classes, comprising:
acquiring at least one image of an envelope;
isolating a plurality of predefined regions of interest within the at least one acquired image of the envelope;
generating a candidate image from each of the plurality of regions of interest;
dividing each candidate image into a plurality of regions;
extracting a plurality of numerical feature values from each of the plurality of regions associated with a given candidate image;
combining the extracted numerical feature values from each of the plurality of regions associated with a given candidate image into a single feature vector representing the candidate image;
determining, for each candidate image, a set of output values, corresponding to the plurality of output classes, from the feature vector, a given output value representing the likelihood that the candidate image belongs to an output class associated with the output value; and
providing the set of output values to at least one downstream analysis element that determines at least one characteristic of the envelope according to the set of output values and at least one additional input representing the envelope.

16. The method of claim 15, wherein extracting a plurality of numerical feature values from each of the plurality of regions comprises constructing a histogram count of the occurrence of a plurality of categories of pixel patterns within a plurality of defined two-pixel by two-pixel squares within each region.

17. The method of claim 16, wherein the plurality of categories of pixel patterns comprise at least a first category representing a two-pixel by two-pixel square having a three dark pixels and a white upper-left pixel, and a second category representing a two-pixel by two-pixel square having three dark pixels and a white lower-right pixel.

18. The method of claim 15, wherein isolating a plurality of predefined regions of interest within the at least one acquired image of the envelope comprises isolating opposing corners of the at least one acquired image.

19. The method of claim 15, further comprising:
selecting one of a plurality of downstream analysis elements according to the set of output values; and
determining at least one characteristic of the envelope at the selected analysis element according to the at least one additional input.

20. The method of claim 15, wherein determining a set of output values from the feature vector comprises providing the feature vector as an input to a neural network classifier.
